(19) United States
(12) Patent Application Publication
(10) Pub. No.: US 2014/0205371 A1
(43) Pub. Date: Jul. 24, 2014

(54) MODULAR RAIL ADAPTER SYSTEM

(71) Applicant: Alexander Bally, Marston Mills, MA (US)

(72) Inventor: Alexander Bally, Marston Mills, MA (US)

(21) Appl. No.: 14/160,087

(22) Filed: Jan. 21, 2014

Related U.S. Application Data
(60) Provisional application No. 61/754,160, filed on Jan. 18, 2013.

(51) Int. Cl. F16B 17/00

(52) U.S. Cl. CPC F16B 17/00
USPC 403/327; 403/361

(57) ABSTRACT

A modular rail adapter that automates latching an adapter to a DIN rail without the need for users to manually latch adapter to a rail. Users simply snap the adapter to the DIN rail in one, continuous movement using a built-in, self-latching catch mechanism. The present adapter eliminates, or greatly reduces the adapter clearance gap to enable a simple, safe, cost effective and user-friendly snap-on mechanism that doesn't require users to remember to latch the accessory being attached to a DIN rail.

### CROSS-REFERENCE TO RELATED APPLICATIONS

This application is related to and claims priority from earlier filed U.S. Provisional Patent Application No. 61/754,160, filed Jan. 18, 2013.

### BACKGROUND OF THE INVENTION

The present invention relates to a modular system for mounting components to a hospital rail system. More particularly, the present invention provides a modular mount that serves to interchangeably attach to the most common rail formats found in hospital facilities.

Typical in a hospital, healthcare or medical environment, wall or equipment-mounted rails are provided which accept snap-on adapters for removably mounting various types of accessories. Such accessories are used daily in the medical environment, including O2 blenders, suction canisters, gas cylinders, shelves, storage baskets, scope hangers, diagnostic instruments, and other accessories. One of the technologies on which these rails and adapters are based was protected under now-expired patents issued to inventor Ernst F. Schindele (Des. 251,855; U.S. Pat. No. 4,498,693; U.S. Pat. No. 4,807,659), known in the industry as Fairfield-type rails and adapters. Additionally, other health care facilities utilize a competing rail system based on the DIN format. DIN rails and adapters are customarily used in Europe and Canada as well as in equipment imported into the USA. DIN rails are rectangular in cross section and, in contrast to Fairfield-type rails based on Schindele, incorporate no recesses into which Fairfield-type adapters can lock. Thus, the unique, popular and safe snap-on mechanism incorporated in the Fairfield-type adapters manufactured by Nexxspan Healthcare LLC. (Formerly Lifespan Healthcare LLC) cannot be utilized on DIN rails.

There presently are no known rail adapters that automatically snap onto DIN rails. Known DIN adapters hook onto the rail at a slight angle and swing into vertical operating position where the user is required to latch/release the adapter to/from the rail by manipulating a catch mechanism or screw knob that typically is not visible behind the accessory item and thus is accessible only by reaching behind the accessory item. This is not only inconvenient and takes time and effort, but also requires users to remember to perform this latching task which is critical for safety. In known DIN adapters, as shown in FIG. 2, the upper leg of the adapter projects rearward from the adapter body at a right angle by a distance approximately equal to the width of the DIN rail. The upper adapter leg terminates in a nose that extends downward at an angle to engage the upper edges of the DIN rail.

Known DIN adapters also feature a lower return leg at the bottom of the adapter that projects rearward at a right angle by a distance approximately equal to the width of the DIN rail. Typically, a lock screw or threaded knob penetrates the return leg, allowing a user to tighten a latching screw against the bottom surface of the DIN rail to prevent the adapter from dislodging after it has been hung on the rail.

To provide adequate clearance to permit the adapter to swing from the angled hooking position to the vertical operating position relative to the rail, the upper adapter leg must be spaced away from the lower return leg by a distance that equals or exceeds the diagonal of the profile of the DIN rail. Thus, with the adapter in the vertical operating position, there is a wide gap between the bottom surface of the DIN rail and the lower return leg which a catching mechanism or locking screw must bridge to securely latch the adapter so the accessory attached to it cannot be dislodged. Known DIN adapters typically have an accessory item attached to their front surfaces. Such adapter-equipped accessories may be hooked over the top of a DIN rail at a slight angle in what is here defined as the angled hooking position. Typically, by grabbing the accessory, the user pivots the adapter from the angled hooking position into what is here defined as the vertical operating position in which the accessory is positioned for use—usually horizontally or vertically. It should be appreciated that the catch mechanism a user must manipulate in known adapters typically is hidden behind the accessory and thus accessible only with difficulty and sometimes is even difficult to see for safety checks.

Thus, to safely use known DIN adapter and rail systems, users have a critical, cognitive task to perform, i.e. remembering to manually latch an accessory. In addition to this cognitive task, users must apply a considerable degree of dexterity, time and energy to tighten (and, during removal of an accessory, loosen) the respective locking device or locking screw.

There is therefore a need for an adapter that hooks over and snaps onto a DIN rail when angular pressure is applied on the adapter or onto the accessory item attached to it. The snap-on mechanism disclosed here utilizes novel geometry to accommodate the rectangular DIN rail profile without reliance on recesses or undercuts that are not part of DIN rails. Further, there is a need for a modular adapter system that can be easily adaptable as between rectangular and shaped rails—the two main formats of rails being Fairfield-type and DIN type rails—thereby reducing the number and complexity of components required to interface with various rails.

### BRIEF SUMMARY OF THE INVENTION

In this regard, the present invention provides for a modular rail adapter that automates the task of latching an adapter to a DIN rail without the need for users to either remember to manually secure the adapter to the rail or to then having to manipulate a catch mechanism, such as applying many turns to a locking knob. The aim is to allow users to simply snap the adapter to the DIN rail in one, continuous movement using a built-in, automatic, self-latching catch mechanism, as further described below.

A crucial step in this invention is to eliminate, or at least greatly reduce, the clearance gap between the bottom surface of the DIN rail and the lower return leg of the adapter that is required to permit the adapter to rotate from an angled hooking position to a vertical operating position without binding up on the diagonal of the DIN rail. Drastically reducing this gap enables a simple, safe, cost effective and user-friendly snap-on mechanism that doesn't require users to remember to latch the accessory being attached to a DIN rail.

The innovation described in this disclosure aims to effectively reduce the clearance gap by which the adapter's upper contact surface is spaced apart from the inner return leg surface of the adapter so that it more closely approximates the height of the DIN rail, yet permits the DIN rail to rotate with its diagonal being contained within the adapter contour. This invention is based on reconfiguring the upper adapter leg and the lower return leg of the adapter, enabling these elements to cooperate with the DIN rail in a novel manner.

To minimize the clearance gap described above, an escape recess is incorporated into the upper leg of the adapter that permits the top rear edge of the DIN rail to move beyond the constraint of the upper adapter leg as the adapter rotates between the angled hooking position and the vertical operating position, effectively eliminating the requirement for a wide clearance gap, as more fully explained below.

These, together with other objects of the invention, along with various features of novelty which characterize the invention, are pointed out with particularity in the claims annexed hereto and form a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a side view of a modular rail adapter of the present invention;

FIG. 2 is a side view of a prior art rail adapter;

FIG. 3 is a side view of the modular rail adapter installed on a DIN type rail;

FIG. 4 is a perspective view of the modular rail adapter on a DIN type rail, with the rail partially inserted;

FIG. 5 is a bottom perspective view of the modular rail adapter;

FIG. 6 is an enlarged side view of the top leg of the modular rail adapter;

FIG. 7 is a perspective view of an alternate embodiment of the modular rail adapter with the catch mechanism placed directly underneath the Fairfield-type rail, with the rail partially inserted;

FIG. 8 is a perspective view of the modular rail adapter embodiment of FIG. 7 with an activation plate;

FIG. 9 is a perspective view of a modular rail adapter with different conversion inserts and a removable mounting plate partially inserted, and the activation plate and catch mechanism cut away;

FIG. 10 is a perspective view of an alternate embodiment of the modular rail adapter with an extended catch mechanism suitable for attaching to different rail types; and

FIG. 11 is a perspective view of multiple modular rail adapters used in conjunction with an extended mounting plate.

### DETAILED DESCRIPTION OF THE INVENTION

Now referring to the drawings, the modular rail adapter system is shown and generally illustrated in the figures. In accordance with the present invention the modular rail adapter 10 disclosed automates the task of latching an adapter to a DIN rail 64 without the need for users to manually latch adapter 10 to rail 64 and to remember to carry out this critical safety task. The aim is to allow users to simply snap adapter 10 to DIN rail 64 in one, continuous movement using a built-in, self-latching catch mechanism, as further described below.

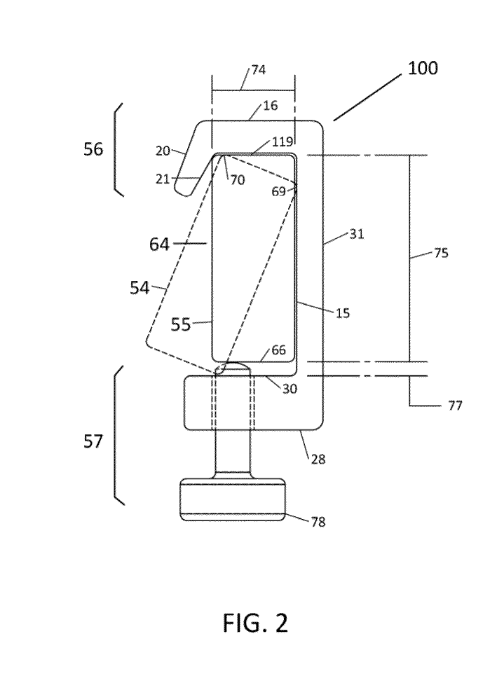

When a known DIN adapter 100 is in its vertical operating position 55, as shown in FIG. 2, it can only be removed from DIN rail 64 by inclining it against the rail until the lower return leg 28 clears the bottom edges of the rail at which point the adapter can be disengaged and removed from the rail. In known DIN adapter systems, this inclining motion requires a wide clearance gap 77 between the inner return leg surface 30 of an adapter 100 and the bottom surface 66 of DIN rail 64 so that the diagonal of rail 64 can be cleared, as described above. The clearance gap 77 in known DIN systems is so wide that it poses a difficult problem for implementing an effective snap-on mechanism. A crucial step in this invention is to eliminate, or at least greatly reduce, this gap 77 to enable a simple, safe, cost effective and user-friendly snap-on mechanism that doesn't require users to remember to latch the accessory being attached to a DIN rail.

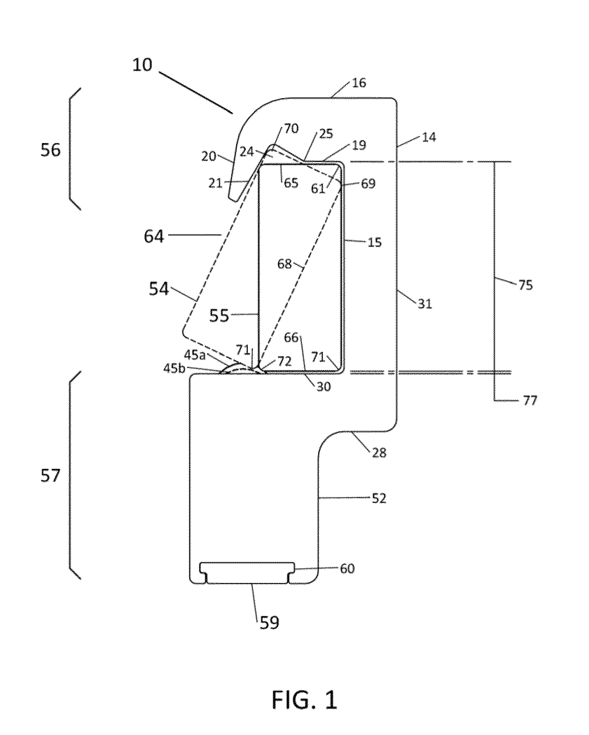

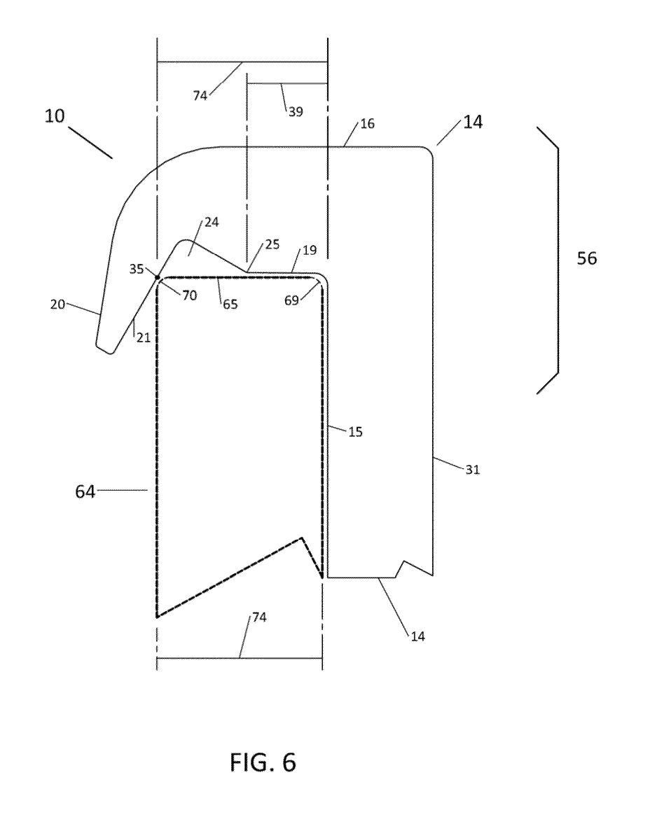

The innovation described in this disclosure is based on reconfiguring the upper restraint 56 and the lower restraint 57, indicated in FIG. 2, permitting these elements to cooperate with DIN rail 64 in a novel manner. Specifically, this invention aims to reduce the spacing between the upper contact surface 19 of the upper adapter leg 16 and the inner return leg surface 30 of the lower return leg 28 so that this spacing more closely approximates the height 75 of DIN rail 64, yet will not bind up against the diagonal of the DIN rail profile when the adapter is pivoted between the inclined hooking position 54 and the vertical operating position 55. As shown in FIGS. 1, 3, 5 and 6, this is accomplished by incorporating an escape recess 24 into upper leg 16 of adapter 10. Escape recess 24 is created at the upper contact surface 19 of adapter 10 adjoining the hook inner surface 21 and permits the top rear edge 70 of DIN rail 64 to move beyond the constraint of the upper contact surface 19 as adapter 10 rotates between the vertical operating position 55 and the angled hooking position 54. This effectively eliminates the need for a wide clearance gap 77, as more fully explained below.

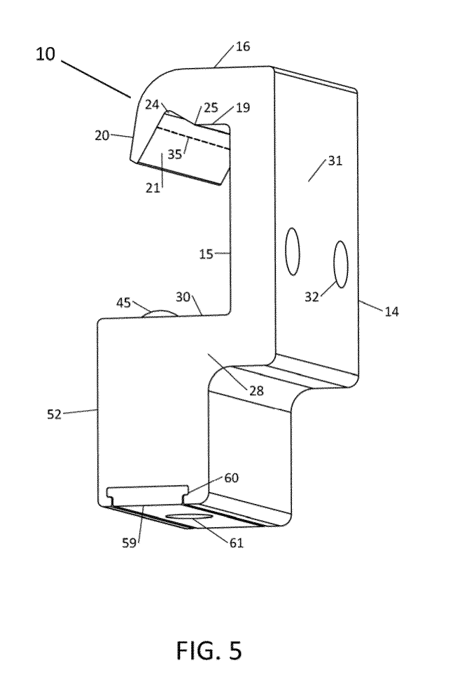

As shown in FIGS. 5 & 6, the edge where the escape recess 24 and the upper contact surface 19 meet is defined as the upper pivot edge 25, and the line where the plane of the upper contact surface 19 intersects the hook inner surface 21 is defined as the hook retention line 35. The horizontal distance between the hook retention line 35 and the inner adapter wall 15 is to be approximately equal to the width 74 of DIN rail 64. This relationship between hook inner surface 21, inner adapter wall 15 and inner return leg surface 30 assures that adapter 10, when in the vertical operating position 55, is trapped so it cannot shift horizontally or vertically against rail 64. However, subject to pivoting motion such as may be exerted on the adapter when removing it from engagement to rail 64 or snapping it onto the rail, the adapter may be pivoted utilizing the escape recess 24. When transitioning between the angled hooking position 54 and the vertical operating position 55, rail 64 is forced upward against the upper contact surface 19 until the top surface 65 of rail 64 is allowed to pivot on pivot edge 25 such that the top rear edge 70 of rail 64 escapes upward into this escape recess 24. During this transition between positions 54 and 55, the bottom front edge 71 of rail 64 glides along the inner return leg surface 30, and the top front edge 69 of the rail glides along the inner adapter wall 15.

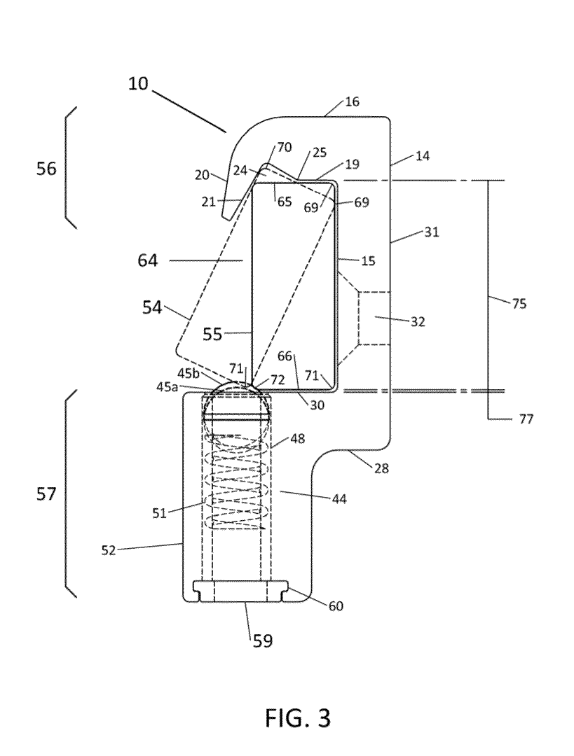

The geometry based on an escape recess 24, and the minimized clearance gap that results, makes it possible to incorporate an efficient catch mechanism 44 into the return leg 28. The catch mechanism 44, indicated in FIG. 3, interacts with the DIN rail bottom surface 66, as well as with the bottom front and rear edges 71, 72, of DIN rail 64. The escape recess 24, in conjunction with catch mechanism 44, permits tight dimensional control of the latching process as a prerequisite for a secure, repeatable snap-on function.

As shown in FIGS. 1 & 6, the configuration of the upper restraint 56 determines the width of the clearance gap 77 between the bottom surface 66 of the rail and the inner return leg surface 30 of adapter 10 with the adapter in the vertical operating position 55. Specifically, the distance between the upper pivot edge 25 and the inner adapter wall 15, here defined as pivot distance 39, determines the required depth and resulting effectiveness of the escape recess 24. Thus, the geometry of the escape recess 24 prevents diagonal binding-up when engaging and disengaging adapter 10 and DIN rail 64. In the preferred embodiment, the upper pivot edge 25 is spaced away from the inner adapter wall 15 by approximately 40 percent of the width 74 of the rail, resulting in a minimal clearance gap 77 that supports a compact catch mechanism 44. However, the pivot distance 39 may be as little as 1 percent, and as much as 80 percent, of the width 74 of rail 64.

As shown in FIGS. 1, 3,4 and 9, this invention incorporates catch mechanism 44 as part of the lower restraint 57. While, in the preferred embodiment, a ball-detent mechanism is utilized, any one of a variety of known mechanisms 44 may be applied to capture adapter 10 on DIN rail 64 in a snap-on manner.

One or more ball detent catch mechanisms 44 may be embedded in base 52 that depends from return leg 28 of adapter 10. In the preferred embodiment, two such ball detent catch mechanisms 44 are used. Each mechanism 44 consists of a generally vertical bore 48 that is sized to loosely contain a hard plastic or steel ball 45 which is biased upward toward the inner return leg surface 30 by a compression spring 46. At the upper end of the vertical bore 48 is a ball retention ledge 49 with an inner diameter slightly smaller in diameter than ball 45. The retention ledge 49 restricts ball 45 from being ejected out of the vertical bore 48 by compression spring 46. Spring 46 is retained by slide lock 59 that, during assembly, is slid into an undercut groove 60 at the bottom of base 52 in order to retain spring 46 of mechanism 44. The compression force exerted by the catch mechanism may be customized for specific applications by installing springs that provide stronger or softer resistance. Thus, the catch mechanisms need not to be individually adjusted and will reliably provide the desired compression force onto the ball 45. The dimensional relationships of the diameter of the vertical bore 48, the retention ledge 49 and the diameter of the ball 45 assure that the ball, when biased against the retention ledge, protrudes from the inner return leg surface 30 by almost one-half a diameter of the ball. The protrusion is enough to assure that the bottom rear and front edges 72, 71 of rail 64 impinge on the ball during insertion and operation.

Note that the ball 45 is shown in different degrees of projection above inner return leg surface 30 in different stages of engagement or disengagement from a rail. For example, in FIGS. 1, 3, 4, 7, 9 and 10, ball 45a is shown retaining a rail; ball 45b is shown fully depressed to allow a diagonally-oriented rail to pass; ball 45c is shown retaining a Fairfield-style rail; and ball 45d is at rest in its fully extending position.

As shown in FIG. 1, ball 45 is positioned in the adapter's return leg 28 such that, in the vertical operating position 55 of adapter 10 in relation to DIN rail 64, the ball (45a) impinges on the rail's bottom rear edge 72 so that the rail is pressed, under spring bias, against upper contact surface 19, inner adapter wall 15 and hook inner surface 21. To disengage adapter 10 from rail 64, a pivoting motion on the adapter forces the rail's bottom rear edge 72 against the spring-loaded ball, causing the ball (45b) to retract against the bias of compression spring 46 so that the bottom rear edge 72 is free to move past the depressed ball. Continued disengaging motion causes ball 45 to glide or roll along the bottom surface 66 of the rail. The ball pops up behind the trailing bottom front edge 71 of the rail, at which point (in its hooking position) the adaptor is free to be removed from the rail. During engagement of the ball to a DIN rail, with adapter 10 hooked onto the rail's top rear edge 70 in the angled hooking position 54, the bottom front edge 71 of rail 64 is forced against the ball (45d)and depresses it. Continued rotation of the adapter to the vertical operating position 55 fully depresses the detent mechanism 44, forcing the ball (45b) against first the bottom front edge 71, and then the bottom surface 66 of the rail. As the adapter is rotated into the vertical operating position 55, the ball (45a) is forced up behind the bottom rear edge 72 of the rail.

As shown in FIGS. 1 & 6, the clearance gap 77 is defined as the space between the bottom surface 66 of DIN rail 64 and the inner return leg surface 30 of adapter 10 when the adapter is in full rail engagement in the vertical operating position 55. The clearance gap 77 may be reduced to near zero as the pivot distance 39 is reduced. In the preferred embodiment, the spring-loaded ball (45a) biases the inner adapter wall 15 against the DIN rail's front surface 68 and the hook inner surface 21 against the top rear edge 70 of the rail. In this configuration, the pivot distance 39 preferably is between 20 percent and 50 percent of the width 74 of DIN rail 64, resulting in a tolerably small clearance gap 77.

Adapter 10 is universal in that it includes mounting holes 32 through which fasteners can be installed to affix any known accessory. By affixing an accessory to adapter 10 via mounting holes 32, the accessory can be then be mounted to, and retained on, a rail system as is presently widely known and available in the clinical setting.

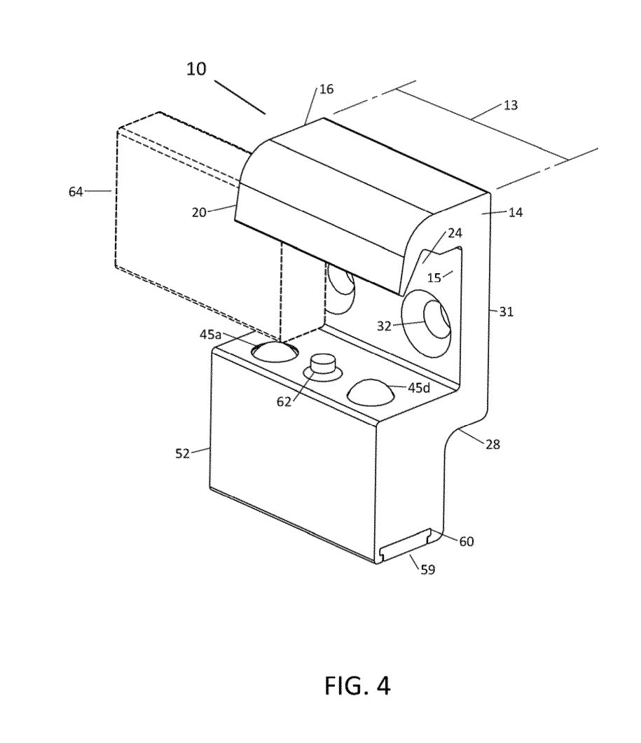

The preferred embodiment of the invention provides adequate retention to safely latch adapters to DIN rails in most applications. However, occasionally, extreme security is required that prevents overpowering the detent mechanism during any accidental or purposeful activity. For such eventualities, one or more set screws 62, as shown in FIGS. 4, 7, 9 and 10, are provided. Using a special tool, set screw 62 may be manually tightened against DIN rail 64 to prevent dislodging. Alternatively, a thumb wheel or lock knob 78 may be substituted for the set screw. In the preferred embodiment, a permanently installed set screw 62 is provided in its retracted position. A screw driver or wrench can be inserted through the access hole 61 provided in the slide lock 59 so users may tighten or loosen the set screw.

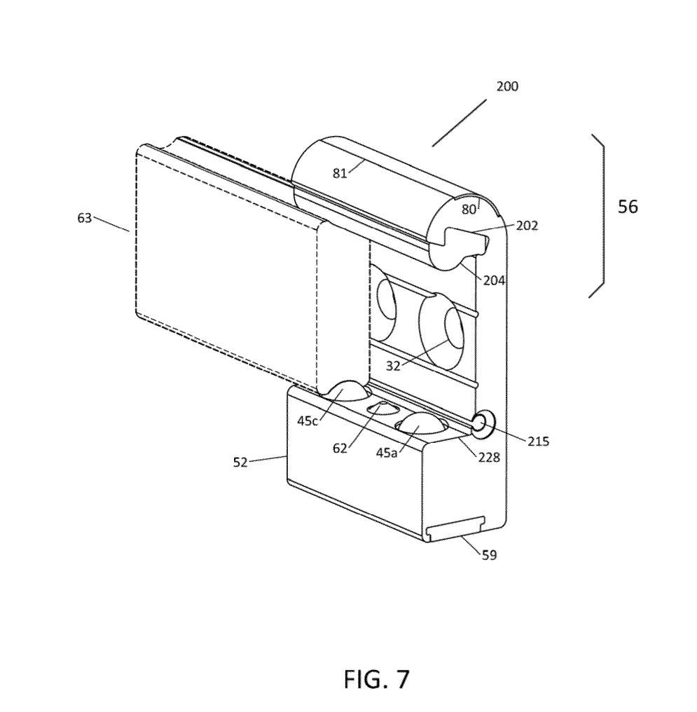

In an alternative embodiment depicted at FIGS. 7, 8 and 9, the adapter 200 is configured to include a top channel 202 to allow adapter 200 to be converted for universal use. The upper restraint 56 of adapter 200 may be provided with channel 202 that allows different converter inserts to be inserted therein to allow the adapter to be modified to fit on the various rail profiles. For example, a rounded-edge insert 204 will engage with the Fairfield-type rail while a DIN insert 206 provides the correct profile and escape recess, as described above, to engage the rectangular shaped DIN rail. In this arrangement it is also of note that the inserts can be formed (preferably extruded) of a hard or soft material wherein a soft material allows the connection to be cushioned in a manner that reduces noise when attaching and/or removing devices—an advantage as abating noise levels in patient care facilities is increasingly important.

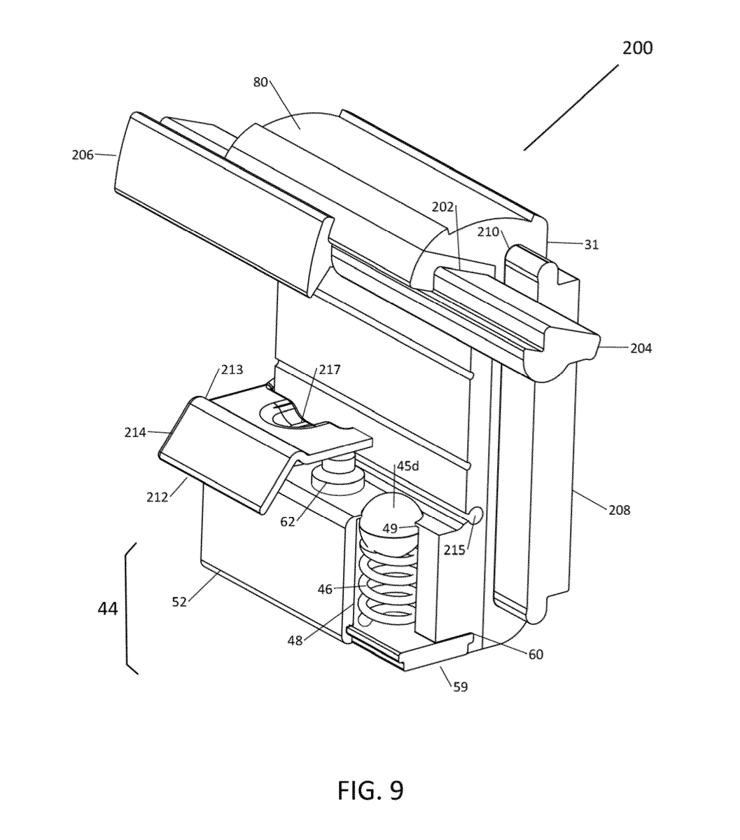

Further, as shown in FIG. 9, a mounting plate 208 may be inserted into channel 210 in the accessory mounting surface 31 of adapter 200. All adapters comprising channel 210 can then be standardized while the rear mounting plates 208 can be customized as needed for the various proprietary devices and accessories that will be attached thereto. This allows the mounting configuration on the face of the mounting plate 208 to be varied while the channel 210 interface in the accessory mating surface 31 of adapter 200 remains unchanged, allowing adapters to be standardized so they can be more efficiently manufactured in greater production volumes.

In an alternative embodiment, as shown in FIGS. 7, 8 and 9, the ball-detent catch mechanism 44 is retained by slide 59 held in grooves 60 at the bottom of base 52 of the adapters, allowing for precise and repeatable setting of retention force when different biasing springs are installed.

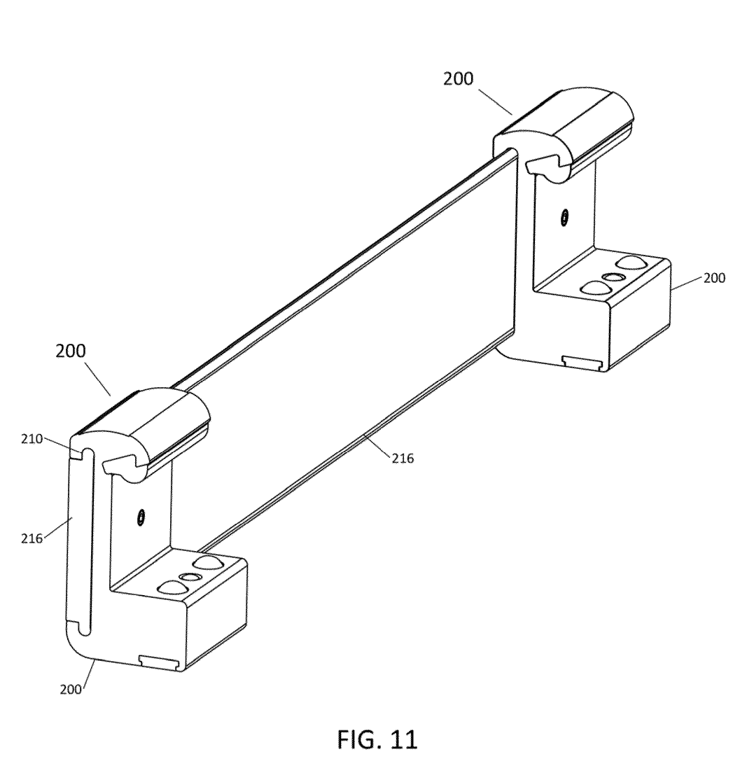

A further embodiment, as shown in FIG. 11, incorporates an extended mounting adapter plate 216, which interconnects two or more adapters 200 and aligns them to provide additional stability when attaching flexible assemblies such as baskets to a rail in order to prevent them from twisting during installation and removal from the rail.

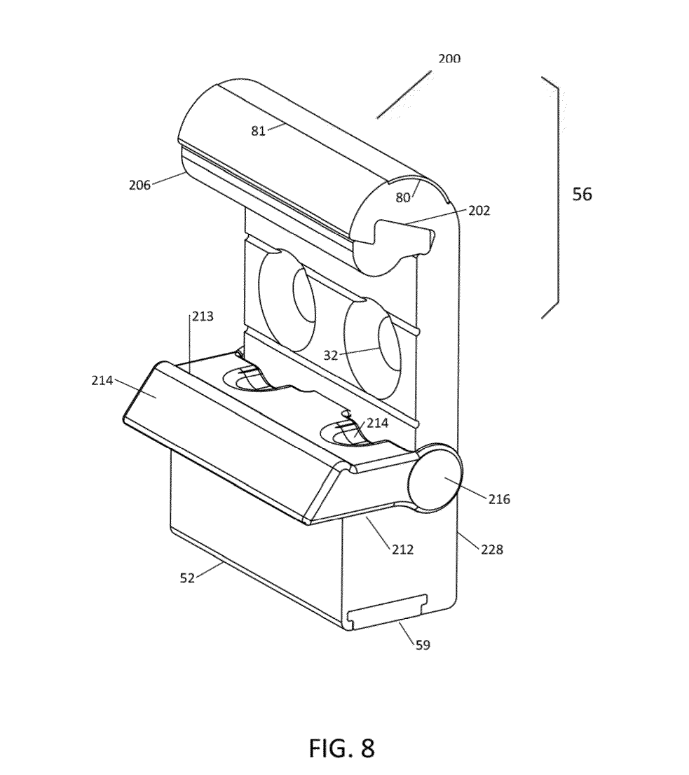

In yet another alternative embodiment, the ball detents of the catch mechanism 44 may be positioned directly underneath the rail so it engages the channel contour on the bottom of Fairfield-type rails 63, as shown in FIG. 7. If this embodiment is to be used with DIN-type rails, the ball detents will impinge against the flat, smooth bottom surface of the DIN-type rail, preventing the ball detent from positively engaging therewith. To overcome this problem, as shown in FIGS. 7, 8 & 9, when the Fairfield-type adapter configuration of FIG. 7 is used with a DIN rail 64, rounded insert 204 suitable for Fairfield-type rails 63 may be replaced by DIN insert 206, and an additional DIN activation plate 212 may also be employed to activate the ball detent mechanism. Plate 212 has a pivoting mount that is biased upward by the ball detent catch mechanism 44 and is affixed to adapter 200 by pivot pins 216 engaged in adapter pivot holes 215. The activation plate 212 includes ramp 214 that guides the bottom front edge of the DIN rail over the retaining lip 213 as adapter 200 is rotated from an angled hooking position to the vertical operating position where retaining lip 213 pops up behind DIN rail 64 to retain it. During deflection of activation plate 212, balls 45 are deflected by activators 217 depending from the underside of the activation plate.

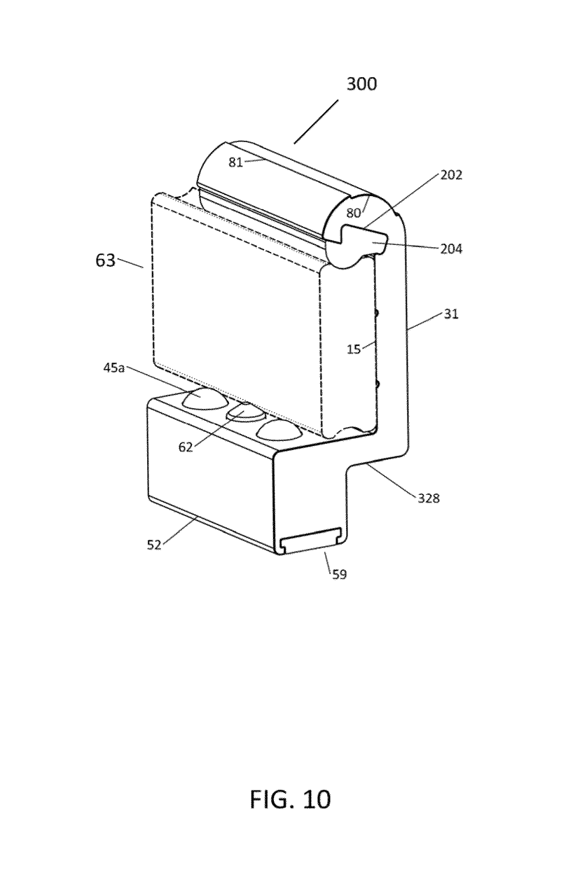

It should be appreciated by one skilled in the art, as shown in FIG. 10, that rather than employing the DIN activation plate 212, the ball detents may alternatively be repositioned by incorporating an extended return leg 328 so that the space between detent balls 45 and the inner adapter wall 15 is suitable for retaining the rear bottom edge 72 of DIN rail 64 and also the rear bottom edge of a Fairfield-type rail 63. Adapter 300 thus can accommodate both Fairfield-type rails 64 and DIN-type rails 64, provided the appropriate insert 204 or 206, respectively, is inserted in top channel 202.

It can therefore be seen that the present invention provides a modular rail adapter that automates the task of latching an adapter to a DIN and Fairfield-type rails without the need for users to either remember to manually latch the adapter to the rail or to then having to expend effort to operate a safety catch or using a locking knob that may be hidden behind an accessory item. Further, the modular rail adapter can be employed with nearly all of the common mounting systems, thereby reducing the need for creating a variety of specialty adapters. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A modular rail adapter for mounting accessories to a rail mounting system comprising:
an adapter body having a rear wall, a top leg, a bottom leg and a channel formed therebetween for mounting onto a rail mounting system;
an escape recess formed in said channel at said top leg, said escape recess allowing an edge of said rail to enter said escape recess when said adapter is tilted relative to said rail; and
a catch mechanism in said bottom leg to releasably engage with said rail when said adapter is installed on said rail.

2. The modular rail adapter of claim 1, wherein said catch mechanism is a ball detent.

3. The modular rail adapter of claim 1, wherein said catch mechanism is a ball detent positioned along said bottom leg at a distance from said rear wall wherein the ball detent engages behind a rear surface of said rail when said adapter is installed on said rail.

4. The modular rail adapter of claim 1, wherein said catch mechanism is a ball detent positioned along said bottom leg at a distance from said rear wall wherein the ball detent engages with a groove in a bottom edge of said rail when said adapter is installed on said rail.

5. The modular rail adapter of claim 4, further comprising:
a DIN activation plate pivotally affixed above said catch mechanism, said DIN activation plate including a lip that engages behind a rear surface of said rail when said adapter is installed on said rail.

6. The modular rail adapter of claim 1, said rear wall including holes for the mounting of accessories thereto.

7. The modular rail adapter of claim 1, said rear wall including a mounting channel for slidably receiving a mounting plate for the mounting of accessories thereto.

8. The modular rail adapter of claim 1, the catch mechanism further comprising:
a ball detent including a spring and a displaceable ball latch biased to a latching position by said spring, said ball detent retained in an opening in said bottom leg by a removable plate.

9. The modular rail adapter of claim 1, the catch mechanism further comprising:
a locking screw to prevent removal of said rail adapter from said rail system.

10. A modular rail adapter for mounting accessories to a rail mounting system comprising:
an adapter body having a rear wall, a top leg, a bottom leg and a channel formed therebetween for mounting onto a rail mounting system;
a channel formed in said top leg to receive an insert adapter, said insert adapter being changeable and allowing said modular rail adapter to be affixed to different profile rail mounting systems; and
a catch mechanism in said bottom leg to releasably engage with said rail when said adapter is installed on said rail.

11. The modular rail adapter of claim 10, further comprising:
an escape recess formed in said insert adapter top leg, said escape recess allowing an edge of said rail to enter said escape recess when said adapter is tilted relative to said rail

12. The modular rail adapter of claim 10, wherein said catch mechanism is a ball detent positioned along said bottom leg at a distance from said rear wall wherein the ball detent engages with a groove in a bottom edge of said rail when said adapter is installed on said rail.

13. The modular rail adapter of claim 12, further comprising:
a DIN activation plate pivotally affixed above said catch mechanism, said DIN activation plate including a lip that engages behind a rear surface of said rail when said adapter is installed on said rail.

14. The modular rail adapter of claim 10, said rear wall including holes for the mounting of accessories thereto.

15. The modular rail adapter of claim 10, said rear wall including a mounting channel for slidably receiving a mounting plate for the mounting of accessories thereto.

16. The modular rail adapter of claim 10, the catch mechanism further comprising:
a ball detent including a spring and a displaceable ball latch biased to a latching position by said spring, said ball detent retained in an opening in said bottom leg by a removable plate.

17. The modular rail adapter of claim 10, the catch mechanism further comprising:
a locking screw to prevent removal of said rail adapter from said rail system.

18. A modular rail adapter for mounting accessories to a rail mounting system comprising:
an adapter body having a rear wall, a top leg, a bottom leg and a channel formed therebetween for mounting onto a rail mounting system; and
a catch mechanism in said bottom leg comprising a ball detent including a spring and a displaceable ball latch biased to a latching position by said spring, said ball detent retained in an opening in said bottom leg by a removable plate,
wherein said catch mechanism releasably engages with said rail when said adapter is installed on said rail

19. The modular rail adapter of claim 18, the catch mechanism further comprising:
a locking screw to prevent removal of said rail adapter from said rail system.

20. The modular rail adapter of claim 18, further comprising:
an escape recess formed in said channel at said top leg, said escape recess allowing an edge of said rail to enter said escape recess when said adapter is tilted relative to said rail.
